(19) United States
(12) Patent Application Publication
(10) Pub. No.: US 2026/0098166 A1
(43) Pub. Date: Apr. 9, 2026

(54) INKJET INK

(71) Applicant: KYOCERA DOCUMENT SOLUTIONS INC., OSAKA-SHI (JP)

(72) Inventor: NORIAKI OZAWA, OSAKA-SHI (JP)

(21) Appl. No.: 19/352,423

(22) Filed: Oct. 7, 2025

(30) Foreign Application Priority Data
Oct. 9, 2024 (JP) 2024-177498

(51) Int. Cl. C09D 11/322

(52) U.S. Cl. CPC C09D 11/322

(57) ABSTRACT

An inkjet ink includes: a pigment; a cyclohexylmethacrylate/methacrylic acid copolymer having a weight average molecular weight of 10,000 or more and 30,000 or less and an acid value of 160 mg KOH/g or more and 200 mg KOH/g or less; a surfactant represented by the following general formula (1); and water.

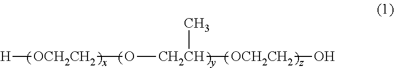

In the general formula (1), x, y, and z represent integers determined to satisfy conditions that the surfactant has a number average molecular weight of 2,000 or more and 2,750 or less and a ratio of a number average molecular weight of only a propyleneoxide chain in the surfactant to the number average molecular weight of the surfactant is 0.82 or more and 0.91 or less.

### CROSS-REFERENCE TO RELATED PATENT APPLICATION

This application claims the benefit of Japanese Priority Patent Application JP 2024-177498 filed Oct. 9, 2024, the entire contents of which are incorporated herein by reference.

### FIELD OF THE DISCLOSURE

The present disclosure relates to an inkjet ink.

### BACKGROUND OF THE DISCLOSURE

Japanese Patent No. 4330262, Japanese Patent Application Laid-open No. 2015-117332, Japanese Patent Application Laid-open No. 2002-088287, and Japanese Patent Application Laid-open No. 2011-140630 disclose inkjet inks for recording an image on a recording medium such as paper. In inkjet inks, a resin can be blended as a binder for retaining the pigment on a recording medium. As a result, inkjet inks are capable of recording a clear image with high image density independent of the type of recording medium.

### SUMMARY OF THE DISCLOSURE

According to an embodiment of the present disclosure, there is provided an inkjet ink, including: a pigment; a cyclohexylmethacrylate/methacrylic acid copolymer having a weight average molecular weight of 10,000 or more and 30,000 or less and an acid value of 160 mg KOH/g or more and 200 mg KOH/g or less; a surfactant represented by the following general formula (1); and water.

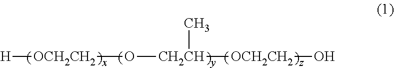

In the general formula (1), x, y, and z represent integers determined to satisfy conditions that the surfactant has a number average molecular weight of 2,000 or more and 2,750 or less and a ratio of a number average molecular weight of only a propyleneoxide chain in the surfactant to the number average molecular weight of the surfactant is 0.82 or more and 0.91 or less.

### DETAILED DESCRIPTION OF THE EXEMPLARY EMBODIMENTS

In inkjet inks that cause a pigment to adhere to a recording medium via a resin, since the pigment tends to retain on the surface of the recording medium, it becomes difficult to ensure sufficient rubfastness as the image density of an image to be recorded on a recording medium increases. Therefore, in such inkjet inks, it is difficult to achieve both image density and rubfastness simultaneously.

In view of the circumstances as described above, it is an object of the present disclosure to provide an inkjet ink capable of achieving both image density and rubfastness.

An embodiment of the present disclosure will be described.

### [Configuration of Ink]

### (Schematic Configuration)

An inkjet ink according to an embodiment of the present disclosure (hereinafter, referred to simply also as an “ink”) includes a pigment a, a pigment dispersion resin b, a surfactant c, and water. The ink according to this embodiment is a water-based ink that is ejected from a recording head of an inkjet recording apparatus onto a recording medium to record an image on the recording medium. The recording medium on which an image is to be recorded by the ink according to this embodiment includes a fiber such as a cellulose fiber. Examples of such a recording medium include plain paper, copy paper, recycled paper, thin paper, and thick paper.

In the ink according to this embodiment, it is possible to achieve both image density and rubfastness by using the pigment dispersion resin b having a specific configuration and the surfactant c having a specific configuration in combination. Details of each component of the ink according to this embodiment will be described below.

### (Pigment a)

The ink according to this embodiment includes the pigment a as a coloring agent from the viewpoints of color mixing prevention and improvement in water resistance in images recorded on the recording medium. The pigment a may be either an inorganic pigment or an organic pigment. Further, as the pigment a, these may be combined with an extender pigment as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. The ink according to this embodiment can use one or two or more selected from these colored pigments as the pigment a.

### (Pigment Dispersion Resin b)

In the ink according to this embodiment, the pigment dispersion resin b is blended as a dispersant that is adsorbed on the surface of the pigment a to enhance the dispersibility of the pigment a in the solvent. Further, the pigment dispersion resin b also functions as a binder for holding the pigment a on the recording medium. In the ink according to this embodiment, fine particles of a cyclohexylmethacrylate/methacrylic acid copolymer are used as the pigment dispersion resin b. In the pigment dispersion resin b, cyclohexylmethacrylate forms a hydrophobic segment and methacrylic acid forms a hydrophilic segment.

Further, in the ink according to this embodiment, the pigment dispersion resin b has a weight average molecular weight of 10,000 or more and 30,000 or less. In the ink according to this embodiment, by setting the weight average molecular weight of the pigment dispersion resin b to 10,000 or more, it is possible to achieve high image density. Further, in the ink according to this embodiment, by setting the weight average molecular weight of the pigment dispersion resin b to 30,000 or less, it is possible to suppress a decrease in rubfastness due to the influence of the pigment dispersion resin b. Note that in this embodiment, the weight average molecular weight and the number average molecular weight are measured using gel permeation chromatography (“HLC-8020GPC” manufactured by TOSOH CORPORATION) in accordance with the following conditions.
Column: “TSKgel SuperMultiporeHZ-H” manufactured by TOSOH CORPORATION (semi-microcolumn of 4.6 mm I.D.×15 cm)
Number of columns: 3
Eluent: tetrahydrofuran
Flow rate: 0.35 mL/min
Sample injection amount: 10 μL
Measurement temperature: 40° C.
Detector: IR detector

Note that the calibration curve is created by selecting seven types, i.e., F-40, F-20, F-4, F-1, A-5000, A-2500, and A-1000, and n-propylbenzene from TSKgel standard polystyrene manufactured by TOSOH CORPORATION.

Further, in the ink according to this embodiment, the pigment dispersion resin b has an acid value of 160 mg KOH/g or more and 200 mg KOH/g or less. As a result, in the ink according to this embodiment, image density can be enhanced without impairing rubfastness. Note that in this embodiment, the acid value is obtained by the method according to JIS K0070:1992.

In the ink according to this embodiment, the content of the pigment dispersion resin b is favorably 4 mass % or more in order to sufficiently achieve the above effect of the pigment dispersion resin b. Further, in the ink according to this embodiment, the content of the pigment dispersion resin b is favorably 5 mass % or less in order to achieve high dispersion stability.

### (Surfactant c)

In the ink according to this embodiment, the surfactant c represented by the following general formula (1) is used. The surfactant c has a propyleneoxide chain (PO chain) forming the central portion and ethyleneoxide chains (EO chains) located on both sides of the PO chain. In the ink according to this embodiment, the surfactant c enhances wettability on a recording medium, thereby achieving the effect of penetrating the pigment a into the recording medium appropriately. As a result, in the ink according to this embodiment, the retained state of pigment a forming the image recorded on the recording medium is easily maintained, and high rubfastness can be easily achieved even if the image density is made high.

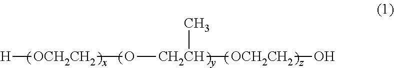

In the general formula (1), x, y, and z represent integers determined to satisfy conditions that the surfactant c has a number average molecular weight of 2,000 or more and 2,750 or less and the ratio of the number average molecular weight of only the PO chain in the surfactant c to the number average molecular weight of the surfactant c (hereinafter, referred to simply also as a “PO chain ratio” is 0.82 or more and 0.91 or less.

In the case where the number average molecular weight of the surfactant c is less than 2,000, the penetration into the recording medium tends to be excessive, making it difficult to achieve high image density. Further, in the case where the number average molecular weight of the surfactant c exceeds 2,750, the penetration into the recording medium is insufficient and it is likely to laterally spread along the recording medium, making it difficult to achieve high rubfastness. Further, in the case where the PO chain ratio is less than 0.82 or exceeds 0.91, the wettability on the recording medium does not sufficiently increase, making it difficult to achieve high rubfastness.

In the ink according to this embodiment, the content of the surfactant c is favorably 0.2 mass % or more in order to sufficiently achieve the above effect of the surfactant c. Further, in the ink according to this embodiment, the content of the surfactant c is favorably 1.0 mass % or less in order to achieve a high ejection property.

### (Water)

In the ink according to this embodiment, ion exchanged water, purified water, distilled water, or the like can be used as water. In the ink according to this embodiment, the content of water is favorably 30 mass % or more and 60 mass % or less from the viewpoints of dryness and ejection reliability.

### (Other Components)

In the ink according to this embodiment, components other than the above may be blended as necessary. For example, in the ink according to this embodiment, a surfactant can be used as a dispersant having the effect of enhancing the dispersibility of the pigment a in the solvent. The surfactant blended as a dispersant is blended separately from the surfactant c, and reduces the interfacial tension between the pigment a and the solvent, thereby enhancing the dispersibility of the pigment a in the solvent. As such a surfactant, for example, a nonionic surfactant or an anionic surfactant can be used.

Further, in the ink according to this embodiment, various additives such as a water-soluble moisturizing agent, a penetrating agent, a dissolution stabilizer, an anti-drying agent, an antioxidant, a viscosity adjustor, a pH adjuster, a neutralizer, and an antifungal agent may be blended as necessary in addition to the surfactant.

### EXAMPLES

Inks were prepared and evaluated as Examples 1 to 4 of the present disclosure.

### (Preparation of Ink)

In Examples 1 to 4, first, a pigment dispersion liquid including the pigment a dispersed in water was prepared. The pigment dispersion liquid was prepared by blending the pigment a, the pigment dispersion resin b, sodium hydroxide, OLFINE (registered trademark) E1010, and water such that the content shown in Table 1 was achieved.

TABLE 1

| Component | Content (mass %) |
|---|---|
| Pigment a | 15 |
| Pigment dispersion resin b | 6.0 |
| Sodium hydroxide | 0~1.0 |
| OLFINE E1010 | 0.5 |
| Water | Remainder |

Sodium hydroxide was blended as a neutralizer for neutralizing the pigment dispersion resin b. OLFINE (registered trademark) E1010 is blended as a dispersant for enhancing the dispersibility of the pigment a in the solvent and is a nonionic surfactant manufactured by Nissin Chemical Co., Ltd. In all of Examples 1 to 4, Pigment Blue 15:3 (“LIONOL BLUE FG-7351” manufactured by Toyocolor Co., Ltd.) was used as the pigment a, and ion exchanged water was used as water.

The pigment dispersion liquid was prepared by mixing the above components by wet dispersion using a media-type wet disperser. Examples of the media-type wet disperser include a wet disperser (more specifically, “Nano Grain Mill” manufactured by ASADA IRON WORKS.CO., LTD., “MSC mill” manufactured by NIPPON COKE & ENGINEERING. CO., LTD., “DYNO (registered trademark)-MILL” manufactured by Shinmaru Enterprises Corporation, and the like).

In the wet dispersion using a media-type wet disperser, media (zirconia beads having a diameter of 0.5 mm) were set in a vessel and the ejection rate was controlled to 200 to 600 g/min, thereby adjusting the average particle diameter of the pigment dispersion in which the dispersant has adhered to the pigment a dispersed in water to 90 to 110 nm. The particle size distribution of the pigment dispersion was measured for a diluted solution obtained by diluting the pigment dispersion liquid 300 times with ion exchanged water using “Zetasizer Nano” manufactured by Sysmex Corporation.

Next, inks according to Examples 1 to 3 were prepared. The inks according to Examples 1 to 3 were prepared by blending the above pigment dispersion liquid, the surfactant c, the water-soluble moisturizing agent, and water such that the content shown in Table 2 was achieved. In all of Examples 1 to 3, 3-methyl-1,5-pentanediol was used as the water-soluble moisturizing agent.

TABLE 2

| Component | Content (mass %) |
|---|---|
| Pigment dispersion liquid | 53.3 |
| Surfactant c | 0.7 |
| Water-soluble moisturizing agent | 30 |
| Water | Remainder |

In the preparation of the inks according to Examples 1 to 3, the components shown in Table 2 were added in order while stirring the solvent using a stirrer. Further, each ink after stirring was filtered using a filter having a pore size of φ5 μm to remove foreign substances, dirt, coarse particles, and the like.

Further, an ink according to Example 4 was prepared. The ink according to Example 4 was prepared by blending the above pigment dispersion liquid, the surfactant c, 1,3-propanediol, triethylene glycol monobutyl ether, and water such that the content shown in Table 3 was achieved.

TABLE 3

| Component | Content (mass %) |
|---|---|
| Pigment dispersion liquid | 53.3 |
| Surfactant c | 0.5 |
| 1,3-propanediol | 30 |
| Triethylene glycol monobutyl ether | 3 |
| Water | Remainder |

In the preparation of the ink according to Example 4, the components shown in Table 3 were added in order while stirring the solvent using a stirrer. Further, each ink after stirring was filtered using a filter having a pore size of q5 μm to remove foreign substances, dirt, coarse particles, and the like.

### (Evaluation of Ink)

For the inks according to Examples 1 to 4, image density and rubfastness were evaluated.

### Method of Evaluating Image Density

In the evaluation of image density, an inkjet recording apparatus (line type, manufactured by KYOCERA Document Solutions Inc.) was used as a tester. In the tester, the drive voltage was set such that the amount of ink to be ejected from one recording head was 12 pL. Using the tester, a solid image of 10 cm×10 cm was formed on a recording medium (“Vitality” manufactured by Xerox Corporation). The recording medium on which the image was formed was left to stand for 12 hours, and then, the image density of the solid image formed on the recording medium was measured using a spectrodensitometer (FD-5, manufactured by Konica Minolta, Inc.). Inks with the image density of 1.3 or more were determined to “Pass” and inks with the image density of less than 1.3 were determined to “Fail”.

### Method of Evaluating Rubfastness

In the evaluation of rubfastness, an inkjet recording apparatus (line type, manufactured by KYOCERA Document Solutions Inc.) was used as a tester. In the tester, the drive voltage was set such that the amount of ink to be ejected from one recording head was 12 pL. Using the tester, a solid image of 10 cm×10 cm was formed on a recording medium (“Vitality” manufactured by Xerox Corporation). A sheet of paper was slid back and forth on the solid image immediately after being formed five times while the sheet of paper is pressed against the solid image with a load of 500 g. Then, the image density of the sliding surface of the sheet of paper was measured using a spectrodensitometer (FD-5, manufactured by Konica Minolta, Inc.). Inks with the maximum value of image density of 0.2 or less were evaluated to “Pass”, and inks with the maximum value of image density of exceeding 0.2 were evaluated to “Fail”.

### Example 1

In Example 1, ink samples 1 to 3 were prepared by the above method using pigment dispersion resins b with various different hydrophobic segments, and the above evaluation was performed for the samples 1 to 3. Note that in all of the samples 1 to 3 according to Example 1, “OLFINE (registered trademark) E1010” manufactured by Nissin Chemical Co., Ltd. was used as the surfactant c.

Table 4 shows the hydrophobic segment, the hydrophilic segment, the molecular weight distribution, and the acid value of the pigment dispersion resin b used in the samples 1 to 3 and the evaluation results of image density and rubfastness for the samples 1 to 3. In the sample 1, favorable evaluation results for both image density and rubfastness were obtained. On the other hand, in the samples 2 and 3 in which the hydrophobic segment of the pigment dispersion resin b is not cyclohexylmethacrylate, image density was evaluated to “Fail”. This is presumably because in the samples 2 and 3, the penetration into the recording medium was excessive.

TABLE 4

| | Pigment dispersion resin b | | | | | |
|---|---|---|---|---|---|---|
| | | | Molecular | | Evaluation result | |
| | Hydrophobic | Hydrophilic | weight | Acid value | Image | |
| No. | segment | segment | distribution | (mgKOH/g) | density | Rubfastness |
| 1 | CyMMA | MAA | 1.0 | 160 | 1.34 | 0.19 |
| 2 | BzMMA | MAA | 1.2 | 160 | 1.27 | 0.17 |
| 3 | St | MAA | 1.1 | 160 | 1.2 | 0.15 |

### Example 2

In Example 2, ink samples 4 to 8 were prepared by the above method using pigment dispersion resins b having various different weight average molecular weights, and the above evaluation was performed for the samples 4 to 8. Note that in all of the samples 4 to 8 according to Example 2, a cyclohexylmethacrylate/methacrylic acid copolymer was used as the pigment dispersion resin b and “OLFINE (registered trademark) E1010” manufactured by Nissin Chemical Co., Ltd. was used as the surfactant c.

Table 5 shows the weight average molecular weight and the acid value of the pigment dispersion resin b used in the samples 4 to 8 and the evaluation results of image density and rubfastness for the samples 4 to 8. In all of the samples 5 to 7, favorable evaluation results for both image density and rubfastness were obtained. On the other hand, in the sample 4 in which the pigment dispersion resin b has a small weight average molecular weight, image density was evaluated to “Fail”. This is presumably because in the sample 4, the penetration into the recording medium was excessive. Further, in the sample 8 in which the pigment dispersion resin b has a large weight average molecular weight, rubfastness was evaluated to “Fail”. This is presumably because in the sample 8, the penetration into the recording medium was insufficient.

TABLE 5

| | Pigment dispersion resin b | | Evaluation result | |
|---|---|---|---|---|
| | Weight average | Acid value | Image | |
| No. | molecular weight | (mgKOH/g) | density | Rubfastness |
| 4 | 8000 | 170 | 1.27 | 0.17 |
| 5 | 11000 | 160 | 1.33 | 0.19 |
| 6 | 21000 | 160 | 1.34 | 0.19 |
| 7 | 30000 | 180 | 1.35 | 0.20 |
| 8 | 32000 | 160 | 1.37 | 0.22 |

### Example 3

In Example 3, ink samples 9 to 13 were prepared by the above method using pigment dispersion resins b having various different acid values, and the above evaluation was performed for the samples 9 to 13. Note that in all of the samples 9 to 13 according to Example 3, a cyclohexylmethacrylate/methacrylic acid copolymer was used as the pigment dispersion resin b and “OLFINE (registered trademark) E1010” manufactured by Nissin Chemical Co., Ltd. was used as the surfactant c.

Table 6 shows the weight average molecular weight and the acid value of the pigment dispersion resin b used in the samples 9 to 13 and the evaluation results of image density and rubfastness for the samples 9 to 13. In all of the samples 10 to 12, favorable evaluation results for both image density and rubfastness were obtained. On the other hand, in the sample 9 in which the pigment dispersion resin b has a small acid value, rubfastness was evaluated to “Fail”. This is presumably because in the sample 9, the penetration into the recording medium was insufficient. Further, in the sample 13 in which the pigment dispersion resin b has a large acid value, image density and rubfastness were evaluated to “Fail”. This is presumably because in the sample 13, the dispersion of the pigment a was unstable.

TABLE 6

| | Pigment dispersion resin b | | Evaluation result | |
|---|---|---|---|---|
| | Weight average | Acid value | Image | |
| No. | molecular weight | (mgKOH/g) | density | Rubfastness |
| 9 | 16000 | 150 | 1.32 | 0.22 |
| 10 | 17000 | 160 | 1.33 | 0.19 |
| 11 | 18000 | 180 | 1.34 | 0.19 |
| 12 | 19000 | 200 | 1.35 | 0.20 |
| 13 | 18000 | 210 | 1.26 | 0.22 |

### Example 4

In Example 4, ink samples 14 to 23 were prepared by the above method using various different surfactants c, and the above evaluation was performed for the samples 14 to 23. Specifically, in the sample 14, “NEWPOL PE-61” manufactured by SANYO CHEMICAL INDUSTRIES, LTD. was used. In the sample 15, “NEWPOL PE-71” manufactured by SANYO CHEMICAL INDUSTRIES, LTD. was used as the surfactant c. In the sample 16, “ADEKA Pluronic L-31” manufactured by ADEKA CORPORATION was used as the surfactant c. In the sample 17, “ADEKA Pluronic L-61” manufactured by ADEKA CORPORATION was used as the surfactant c. In the sample 18, “ADEKA Pluronic L-81” manufactured by ADEKA CORPORATION was used as the surfactant c. In the sample 19, “NEWPOL PE-62” manufactured by SANYO CHEMICAL INDUSTRIES, LTD. was used as the surfactant c. In the sample 20, “NEWPOL PE-34” manufactured by SANYO CHEMICAL INDUSTRIES, LTD. was used as the surfactant c. In the sample 21, “NEWPOL PE-64” manufactured by SANYO CHEMICAL INDUSTRIES, LTD. was used as the surfactant c. In the sample 22, “NEWPOL PE-74” manufactured by SANYO CHEMICAL INDUSTRIES, LTD. was used as the surfactant c. In the sample 23, polypropylene glycol was used as the surfactant c. Note that in all of the samples 14 to 23 according to Example 4, a cyclohexylmethacrylate/methacrylic acid copolymer was used as the pigment dispersion resin b.

Table 7 shows the number average molecular weight, the number average molecular weight of the PO chain, and the PO chain ratio of the surfactant c used in the samples 14 to 23, and the evaluation results of image density and rubfastness for the samples 14 to 23. In all of the samples 14, 15, 17, and 18, favorable evaluation results for both image density and rubfastness were obtained. On the other hand, in the sample 16 in which the surfactant c has a small number average molecular weight, image density was evaluated to “Fail”. This is presumably because in the sample 16, the penetration into the recording medium was excessive. Further, in all of the samples 19 to 22 in which the PO chain ratio in the surfactant c is low and the sample 23 in which the PO chain ratio is high, rubfastness was evaluated to “Fail”. This is presumably because in the samples 19 to 23, the wettability on the recording medium did not sufficiently increase.

TABLE 7

| | Surfactant c | | | | |
|---|---|---|---|---|---|
| | Entire number | Number average | | | |
| | average | molecular | PO | Evaluation result | |
| | molecular | weight | chain | Image | |
| No. | weight | of PO chain | ratio | density | Rubfastness |
| 14 | 2,000 | 1,750 | 0.88 | 1.31 | 0.19 |
| 15 | 2,200 | 2,000 | 0.91 | 1.32 | 0.18 |
| 16 | 1,100 | 950 | 0.86 | 1.28 | 0.19 |
| 17 | 2,000 | 1,750 | 0.88 | 1.32 | 0.19 |
| 18 | 2,750 | 2,250 | 0.82 | 1.33 | 0.19 |
| 19 | 2,400 | 1,750 | 0.73 | 1.32 | 0.24 |
| 20 | 1,700 | 1,000 | 0.59 | 1.33 | 0.24 |
| 21 | 3,100 | 1,750 | 0.56 | 1.31 | 0.23 |
| 22 | 3,100 | 2,000 | 0.65 | 1.32 | 0.22 |
| 23 | 2,000 | 2,000 | 1.00 | 1.32 | 0.22 |

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a cyclohexylmethacrylate/methacrylic acid copolymer having a weight average molecular weight of 10,000 or more and 30,000 or less and an acid value of 160 mg KOH/g or more and 200 mg KOH/g or less;
a surfactant represented by the following general formula (1); and
water, 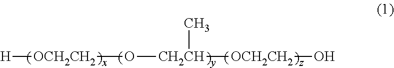
wherein, in the general formula (1), x, y, and z represent integers determined to satisfy conditions that the surfactant has a number average molecular weight of 2,000 or more and 2,750 or less and a ratio of a number average molecular weight of only a propyleneoxide chain in the surfactant to the number average molecular weight of the surfactant is 0.82 or more and 0.91 or less.
